(19) United States
(12) Patent Application Publication
(10) Pub. No.: US 2026/0058928 A1
(43) Pub. Date: Feb. 26, 2026

(54) ADDING ROLES TO NETWORK ADDRESS MAPPING INFORMATION

(71) Applicant: HEWLETT PACKARD ENTERPRISE DEVELOPMENT LP, Spring, TX (US)

(72) Inventors: Rajib Majila, Bangalore (IN); Ram Lakhan Patel, Bangalore (IN)

(21) Appl. No.: 18/919,645

(22) Filed: Oct. 18, 2024

(30) Foreign Application Priority Data
Aug. 22, 2024 (IN) 202441063593

(51) Int. Cl. H04L 61/09

(52) U.S. Cl. CPC H04L 61/09

(57) ABSTRACT

In some examples, a controller obtains an Internet Protocol (IP) address of a compute entity that is to communicate over a network, and determines a role for the compute entity by accessing, using the obtained IP address, a role mapping data structure that maps IP addresses to roles. The controller adds the determined role to network address mapping information in the network, the network address mapping information including entries having respective network addresses, the determined role in the network address mapping information for use by a network device of the network in applying policy enforcement for traffic through the network device.

### BACKGROUND

Compute entities are able to communicate with one another or access resources in a network environment. The compute entities can be divided into multiple groups according to roles of the compute entities. Group-based policies can be applied at enforcement points in the network environment.

### BRIEF DESCRIPTION OF THE DRAWINGS

Some implementations of the present disclosure are described with respect to the following figures.

FIG. 1 is a block diagram of an arrangement including network switches and a control plane for the network switches, according to some examples.

FIG. 2 is a flow diagram of a controller process according to some examples.

FIG. 3 is a block diagram of a controller according to some examples.

FIG. 4 is a block diagram of a network device according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Group-based policies that are applied with respect to respective groups of compute entities can control the manner in which the compute entities are able to communicate in a network environment, what resources are accessible by the compute entities, actions that may be taken by the compute entities, or other aspects of the compute entities. To determine which group a particular compute entity is to be assigned, a role of the particular compute entity is determined. A “role” of a compute entity can refer to a property (or properties) of the compute entity, and/or of a user of the compute entity. For example, a role of the compute entity can include any or some combination of the following: a guest role (indicating that the compute entity is associated with a user that is visiting the network environment), a role of a specific department within an organization (indicating that the compute entity belongs to a user that works in the specific department), a responsibility or assigned function of the compute entity, a capability of the compute entity, or any other characteristic of the compute entity.

Various techniques may be used to assign roles to the compute entities. One way of assigning a role to a compute entity can be during an authentication process for deployment of the compute entity, where the authentication process may be according to the Institute of Electrical and Electronics Engineers (IEEE) 802.1X standards. However, certain types of compute entities (such as virtual compute entities and services) are not subject to authentication processes, so the use of authentication to obtain roles for such compute entities is not available.

In other examples, an administrator may manually assign a role to a compute entity. A role of a compute entity may be identified based on several factors. In some examples, a role may be based on a Media Access Control (MAC) address of the compute entity. In other examples, a role may be based on an Internet Protocol (IP) address of a compute entity. For ease of administration of roles in deployments where IP addresses are used for role identification, aggregated IP addresses may be used to assign roles to compute entities. In other words, a role may be assigned based on an aggregation of IP addresses to reduce the quantity of role configurations that have to be performed by an administrator. An aggregation of IP addresses may or may not match a range of IP addresses associated with an IP subnet configured by the administrator. Hence, a network device should be able to identify the role of a compute entity for packets communicated with the compute entity independent of the IP subnet configuration. To determine a role of the compute entity, a longest prefix match (discussed further below) of an IP address of the compute entity to the aggregations of IP addresses is performed.

In some examples, for fast identification of the role of a compute entity, a network device may employ Ternary Content-addressable Memory (TCAM) resources. A TCAM is a hardware component, and is included in a network device (e.g., a router or switch) for accelerating the process of routing and forwarding by quickly matching network addresses to corresponding entries in a forwarding table. TCAM resources may be used to hold information correlating configured roles with aggregations of IP addresses. However, using TCAM resources to map roles to IP addresses based on longest prefix matching is wasteful since TCAM resources are expensive and should be preserved for other purposes. Also, using TCAMs to identify roles of compute entities does not scale well. As the number of groups of compute entities grow, a TCAM may be inadequate for use in identifying roles of such groups.

In accordance with some implementations of the present disclosure, to address one or more of the foregoing issues, a controller in a control plane is able determine roles of compute entities based on Internet Protocol (IP) addresses by using a role identification data structure that maps the IP addresses (or more specifically, aggregations of IP addresses) to respective roles. The roles determined by the control plane can be used in a data plane when communicating data packets. When an IP address of a compute entity is obtained (such as when a new compute entity joins a network environment or when a compute entity is replaced, updated, or migrated), the controller in the control plane for the network environment can use the obtained IP address to perform a lookup of the role identification data structure to retrieve a role mapped to the obtained IP address. The controller then programs the retrieved role into network address mapping information that has entries including respective network addresses. Examples of the network address mapping information include a Media Access Control (MAC) address table and an Address Resolution Protocol (ARP) table. More generally, the network address mapping information maps network addresses to information that can be used for communicating data packets. After roles are programmed into respective entries of the network address mapping information, the roles can be obtained by a network device in the data plane of the network environment when applying policy enforcement for traffic through the network device.

In some examples, roles of compute entities can be used as part of segmentation of traffic communicated through a network environment. Note that the segmentation of traffic can be further based on other attributes in addition to roles. The segmentation of traffic based on attributes including roles can allow for dynamic application of policies to traffic associated with different segments. Different segments can be associated with different group-based policies that can be enforced.

It is noted that a source compute entity (the compute entity that sends traffic) has a source role, and a destination compute entity (the compute entity that receives the traffic sent by the source compute entity) has a destination role. The source and destination roles may be the same or may be different. A group-based policy applied by an enforcement point (e.g., an egress network device connected to the destination compute entity) can be based on the source and destination roles.

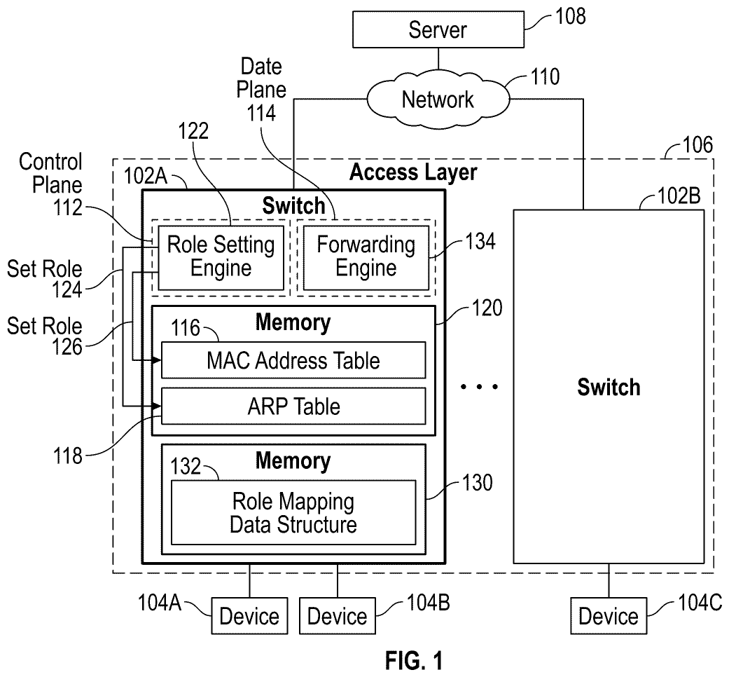

FIG. 1 is a block diagram of an example network environment that includes various network switches 102A and 102B to which are connected electronic devices 104A, 104B, and 104C. Each network switch can be connected to one or more electronic devices. In the depicted example, the electronic devices 104A and 104B are connected to the network switch 102A, and the electronic device 104C is connected to the network switch 102B. Although specific quantities of electronic devices and network switches are shown in FIG. 1, in different examples, a different quantity of network switches and/or a different quantity of electronic devices may be present.

The network switches 102A and 102B are part of an access layer 106 through which the electronic devices 104A, 104B, and 104C can communicate. Each network switch includes a data plane (e.g., 114 in the network switch 102A) through which data (contained in packets) of endpoint devices are transferred. The endpoint devices include the electronic devices 104A, 104B, and 104C, as well as a server 108 (and other devices) connected over a network 110. The network switches 102A and 102B are also connected to the network 110. A network switch is an example of a network device that is used for forwarding data of an endpoint device. Other examples of network devices include a router, a gateway, or any other type of network device.

FIG. 1 shows various components of the network switch 102A. The network switch 102B can include similar components as the network switch 102A.

In FIG. 1, the electronic devices 104A, 104B, 104C and the server 108 are examples of physical compute entities. In some cases, a physical compute entity can execute one or more virtual compute entities, such as virtual machines (VMs) or containers.

In addition to the data plane, the network environment further includes a control plane (e.g., 112) in each network switch, where the control plane performs control functionalities with respect to the network switches 102A and 102B, such as by providing and updating network address mapping information of the network switches 102A and 102B. Although FIG. 1 shows an example in which the control plane (e.g., 112) is provided in a network switch, in other examples, the control plane may be in a controller outside the network switches 102A and 102B, and this controller can be used to perform control functionalities with respect to the network switches 102A and 102B.

In some examples, the network address mapping information in a network switch can include a MAC address table and an ARP table. As shown in FIG. 1, network switch 102A includes a memory 120 storing a MAC address table 116 and an ARP table 118. In some examples, the memory 120 can be part of the hardware (e.g., a programmable integrated circuit device or another hardware component) and the MAC address table 116 and the ARP table 118 in this memory 120 are used by a forwarding engine 134 in the data plane 114 for forwarding packets. The network switch 102A may further include another memory (e.g., 130) used by machine-readable instructions of the network switch 102a, and this other memory may also store a MAC address table and an ARP table. Although specific examples of network address mapping information are provided, it is noted in other examples, different types of network address mapping information can be employed by a network switch.

The forwarding engine 134 in the network switch 102A can use the MAC address table 116 to forward switched traffic, and the forwarding engine 134 uses the ARP table 118 for forwarding routed traffic. Switched traffic includes a data packet that contains a destination MAC address used for identifying a network path over which the network switch is to forward the data packet. Routed traffic includes a data packet containing source and destination IP addresses used for determining a network path for forwarding the data packet. In routed traffic, the ARP table 118 is used to perform a lookup of a destination MAC address corresponding to a destination IP address, so that the obtained destination MAC address can be used for forwarding a data packet based on the MAC address table 116.

In accordance with some examples of the present disclosure, the control plane 112 includes a role setting engine 122 that is able to determine a role for a computing entity, such as an electronic device or a virtual compute entity in an electronic device. In some examples, the memory 130 of the network switch 102A stores a role mapping data structure 132 that is used by the role setting engine 122. The memory 130 may be the same as or different from the memory 120. In examples where the control plane 112 is outside the network switch 102A, the memory 130 can also be external to the network switch 102A. The role mapping data structure 132 correlates roles to IP addresses (or more specifically, aggregations of IP addresses). An “aggregation of IP addresses” refers to a group of one or more IP addresses. For example, a group of IP addresses can be defined by a routing prefix of an IP address. An IP address includes two parts: a routing prefix and a host identifier. The routing prefix identifies a range of IP addresses, while the host identifier identifies a host, such a virtual compute entity or a physical compute entity.

Once an IP address of a compute entity is obtained by the role setting engine 122, the role setting engine 122 can use the determined IP address of the compute entity to look up the role mapping data structure 132 to retrieve an entry in the role mapping data structure 132. The retrieved entry includes the role that is correlated to the IP address of the computing entity.

A role is mapped by an entry of the role mapping data structure 132 to an aggregation of IP addresses. Based on an individual IP address of a compute entity, the role setting engine 122 performs a longest prefix match of the individual IP address to the IP addresses included in the entries of the role mapping data structure 132. Each entry of the role mapping data structure 132 includes an IP address with an IP mask that indicates the part of the IP address that forms the routing prefix. For example, an IP address 174.24.0.2/24 has an IP mask of “24” following the “/” character. The IP mask in this example IP address refers to the number of bits (24 bits) that are all set to “1” to indicate the length of the routing prefix of the IP address. It is possible for the individual IP address (e.g., 172.24.0.8) of the compute entity to match multiple IP addresses in different entries of the role mapping data structure 132 (e.g., a first entry containing 174.24.0.2/24 and a second entry containing 174.24.1.6/16). However, the longest prefix match is to the first entry, since more leading bits of the individual IP address match the IP address (174.24.0.2/24) in the first entry than the IP address (174.24.1.6/16) in the second entry. Note that it is possible for a role to be mapped to the entirety of an IP address (e.g., 32 bits of an IP version 4 (IPv4) address or 128 bits of an IP version 6 (IPv6) address). In this latter case, the “aggregation of IP addresses” mapped to a role would be a single IP address made up of the entire address length of the IP address.

Once the role of the compute entity is determined, the role setting engine 122 is able to set the role (at 124) in an entry of the ARP table 118, and similarly, set the role (at 126) in an entry of the MAC address table 116. Setting the role in the MAC address table 116 or the ARP table 118 refers to adding the role (or more specifically, information describing the role) to the MAC address table 116 or the ARP table 118.

The MAC address table 116 includes entries that correlate MAC addresses to respective physical interfaces over which packets are to be forwarded. In accordance with some examples of the present disclosure, each entry of the MAC address table 116 further correlates a MAC address to a role added by the role setting engine 122.

The ARP table 118 includes entries that correlate host IP addresses to MAC addresses. A host IP address is the IP address of a compute entity. Given a host IP address, the network switch 102A can perform a lookup of the ARP table 118 to retrieve the corresponding MAC address. In accordance with some examples of the present disclosure, each entry of the ARP table 118 further correlates a host IP address to a role added by the role setting engine 122.

Generally, in accordance with some examples of the present disclosure, network address mapping information such as the MAC address table 116 and the ARP table 118 includes entries that map respective network addresses to corresponding roles set by the role setting engine 122 of the control plane 112. In some examples, the network addresses mapped to respective roles by entries of the network address mapping information include an IP address or a MAC address.

As part of forwarding data sent from or destined to a compute entity in the data plane, a network switch can determine the role of the compute entity based on the network address of the compute entity using the network address mapping information. The determined role can then be used to select a group-based policy (from among multiple group-based policies) corresponding to the role, and the group-based policy is applied to determine an enforcement action to apply with respect to the data so that permissible traffic patterns can be defined. Examples of enforcement actions can include any or some combination of the following: drop a data packet, allow a data packet, apply malware scanning, or any other type of action.

In some examples, the role mapping data structure 132 is in the form of a role trie. More specifically, the trie role can include a Patricia trie (also referred to as a radix tree). A trie is a tree-based data structure used for locating specific keys. In a role trie, the keys include IP addresses of compute entities. The role trie includes a root node, intermediate nodes connected to the root node, and leaf nodes connected to the intermediate nodes. Each leaf node maps an IP address of a compute entity to a corresponding role.

In other examples, the role mapping data structure 132 is in a different form, such as a simple list of entries mapping IP addresses to roles, a sorted list (e.g., sorted based on the length of a prefix of an IP address) of entries mapping IP addresses to roles, a binary search tree, or any other type of data structure.

In some examples, the network 110 is a Layer 3 underlay network, such as an IP underlay network. A Layer 2 overlay network, e.g., an Ethernet network, can be provided over the Layer 3 underlay network. A protocol that supports communications through a Layer 2 overlay network provided over a Layer 3 underlay network is the Virtual Extensible Local Area Network (VXLAN) protocol. According to the VXLAN protocol, virtual tunnels referred to as VXLAN tunnels can be established between virtual tunnel endpoints (VTEPs) to communicate data. A VXLAN tunnel encapsulates Layer 2 frames of the Layer 2 overlay network as payloads in Layer 3 packets. The Layer 3 packets are communicated through the Layer 3 underlay network. A network in which frames of a Layer 2 overlay network are carried in a Layer 3 underlay network is referred to as an “underlay and overlay network.” A network device, such as a network switch or another type of network device that forwards data, can include a VTEP, which is a data plane entity that performs VXLAN encapsulation and decapsulation.

Although reference is made to VXLAN in some examples, it is noted that in other examples, VXLAN is not employed. In such other examples, the network 110 can include any other type of network, including a local area network (LAN), a wide area network (WAN), the Internet, or any other type of network.

Various different types of traffic flow may be present in a network environment, such as the network environment shown in FIG. 1. An access-to-access traffic flow involves a source device and a destination device that are both connected to the same network switch. In FIG. 1, an access-to-access traffic flow can be established between the electronic device 104A and the electronic device 104B, which are both connected to the network switch 102A. If both the electronic devices 104A and 104B belong to the same virtual local area network (VLAN), data packets communicated between the electronic devices 104A and 104B are part of switched traffic. The forwarding engine 134 in the network switch 102A uses the MAC address table 116 to determine a network path over which the switched traffic is to be forwarded. However, if the electronic devices 104A and 104B belong to different VLANs, data packets communicated between the electronic devices 104A and 104B are part of routed traffic, in which case the forwarding engine 134 uses the ARP table 118 to determine the MAC address for forwarding the data packets. For switched traffic, a MAC address in a data packet is matched to an entry of the MAC address table 116 to determine the role of the compute entity involved in the communication of the data packet. For routed traffic, an IP address in a data packet is matched to an entry of the ARP table 118 to determine the role of the compute entity involved in the communication of the data packet. The match of a network address (MAC address or IP address) to the MAC address table 116 or the ARP table 118 is an exact match (as compared to a longest prefix match), since the entirety of the network address is compared to addresses in the entries of the MAC address table 116 or the ARP table 118 to find an exact match.

Note that one of the electronic devices 104A, 104B is a source device, and the other one of the electronic devices 104A, 104B is the destination device. The network switch 102A can determine, using the MAC address table 116 or the ARP table 118, the role of the source device (referred to as the “source role”) and the role of the destination device (referred to as the “destination role”). The source role and the destination role in combination are used to determine a group-based policy to apply at the network switch 102A. In some examples, a look-up of a TCAM (not shown) in the network switch 102A based on the source and destination roles can be used to identify the group-based policy to apply. In other examples, other data structures can be used by the network switch 102A to select the group-based policy to apply based on the source and destination roles.

Another type of traffic flow is an access-to-network traffic flow, in which packets traverse from a source compute entity through the access layer 106 to a destination compute entity coupled to the network 110, such as through a VXLAN tunnel between the source compute entity and the destination compute entity. An example of the access-to-network traffic flow includes a traffic flow from one of the electronic devices 104A to 104C to the server 108. Another example of the access-to-network traffic flow includes a traffic flow from the electronic device 104A or 104B (connected to the network switch 102A) to the electronic device 104C (connected to the network switch 102B), or vice versa. In an example, it is assumed that the electronic device 104A is a source device, and the electronic device 104C is a destination device. In this example, the network switch 102A is the ingress switch connected to the source device, and the network switch 102B is the egress switch connected to the destination device. The ingress switch can determine a source role of source device based on a lookup of the MAC address table 116 or the ARP table 118 using the network address of the source device. The ingress switch can then add an indicator of the source role, such as in the form of a role tag included in a VXLAN header in examples where a VTEP in the ingress switch applies VXLAN encapsulation of a packet. When the egress switch receives the VXLAN encapsulated packet, the egress switch can determine the source role using the role tag, and further perform a lookup of a MAC address table or an ARP table in the egress switch to determine the destination role of the destination device. The source role and the destination role in combination are used to determine a group-based policy to apply at the egress switch.

A further type of traffic flow is a network-to-access traffic flow, in which packets traverse from a source compute entity coupled to the network 110 through the access layer 106 to a destination compute entity, such as through a VXLAN tunnel between the source compute entity and the destination compute entity. An example of the network-to-access traffic flow includes a traffic flow from the server 108 to one of the electronic devices 104A to 104C. Another example of the network-to-access traffic flow includes a traffic flow from the electronic device 104C to the electronic device 104A or 104B, or vice versa. In an example, it is assumed that the server 108 is a source device, and the electronic device 104A is a destination device. In this example, a network switch (not shown) to which the server 108 is connected is the ingress switch, and the network switch 102A is the egress switch connected to the destination device. In response to receiving a VXLAN encapsulated packet, the egress switch decapsulates the VXLAN encapsulated packet, and determines the source role using the role tag in the VXLAN header. The egress switch can determine a destination role of destination device based on a lookup of the MAC address table 116 or the ARP table 118 using the network address of the destination device. The source role and the destination role in combination are used to determine a group-based policy to apply at the egress switch.

In any of the foregoing types of traffic flows, roles of compute entities are identified using role information programmed in MAC address tables and ARP tables. The identified roles are then used to select group-based policies for enforcement. The roles programmed into the MAC address tables and ARP tables (which are examples of exact match tables) are derived based on entries of the role mapping data structure 132 that correlate roles to aggregations of IP addresses. It is noted that an aggregation of IP addresses correlated to a role in the role mapping data structure 132 may or may not match a range of IP addresses associated with an IP subnet in the network environment. Hence, a network device should be able to identify the role of a compute entity for packets communicated with the compute entity independent of the IP subnet configuration.

Since network address mapping information such as MAC address tables and ARP tables are already stored and used by network devices for forwarding data, adding role information to entries of the network address mapping information does not meaningfully consume additional memory resources used for storing the network address mapping information, since the role information can be represented using a relatively small quantity of bits in each entry of the network address mapping information. Also, obtaining role information from an entry of the network address mapping information can be efficiently performed since the network address mapping information is accessed for data forwarding.

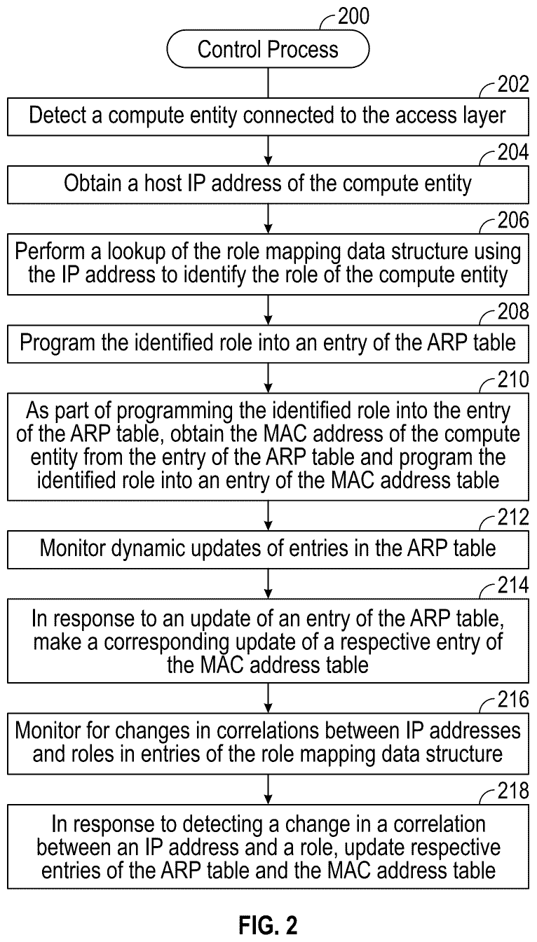

FIG. 2 is a flow diagram of a control process 200 that can be performed by the control plane 112 of FIG. 1. FIG. 2 shows an order of tasks. In other examples, the tasks can be performed in a different order, some of the tasks may be omitted, and other tasks added.

The control plane 112 detects (at 202) a compute entity connected to the access layer 106 (and more specifically, to a network switch in the access layer 106). The compute entity can be the electronic device 104A, 104B, or 104C, or a virtual compute entity in one of the electronic devices. The compute entity can be detected by the control plane 112 when the compute entity is newly added to a network by connecting to a network switch, such as when the compute entity initially joins the network or has been reconfigured.

The control plane 112 obtains (at 204) a host IP address of the compute entity. A newly added compute entity will not have a MAC address in the MAC address table 116. The MAC address of this newly added compute entity is a newly learnt MAC address that does not yet exist in the MAC address table 116. To obtain the IP address of the newly added compute entity, the control plane 112 performs a reverse ARP lookup of the ARP table 118. If an entry exists in the ARP table 118 for the newly learnt MAC address, then the control plane 112 retrieves, from this entry, the host IP address of the newly added compute entity. If an entry does not exist in the ARP table 118 for the newly learnt MAC address, then the control plane 112 can add a new entry to the ARP table 118, where this new entry correlates the newly learnt MAC address to the host IP address of the newly added compute entity.

Once the IP address of the compute entity is obtained, the role setting engine 122 of the control plane 112 performs a lookup (at 206) of the role mapping data structure 132 using the IP address to identify the role of the compute entity. This lookup retrieves an entry from the role mapping data structure 132 (e.g., a role trie or another type of data structure), where the entry from the role mapping data structure 132 contains role information specifying the role corresponding to the IP address. The lookup of the role mapping data structure 132 involves a longest prefix match of the IP address to IP addresses in entries of the role mapping data structure 132. In examples where the role mapping data structure 132 is a role trie, the lookup starts at the root of the role trie and proceeds through intermediate nodes of the role trie until a match to an entry of a leaf node of the role trie is detected.

The role setting engine 122 then programs (at 208) the identified role into an entry of the ARP table 118. Programming the identified role into the entry of the ARP table 118 includes writing role information specifying the identified role into the entry.

As part of programming the identified role into the entry of the ARP table 118, the role setting engine 122 obtains the MAC address of the compute entity from the entry of the ARP table 118. The role setting engine 122 programs (at 210) the identified role into an entry of the MAC address table 116.

The control plane 112 further monitors (at 212) dynamic updates of entries in the ARP table 118. An entry of the ARP table 118 may be updated to provide a new host IP address to MAC address association. In response to an update of an entry of the ARP table 118, the role setting engine 122 of the control plane 112 can make a corresponding update (at 214) of a respective entry of the MAC address table 116. For example, a given entry of the MAC address table 116 contains a first MAC address of a compute entity and a role field set to the role of the compute entity. In this example, an entry of the ARP table 118 contains a mapping between the first MAC address of the compute entity and a first IP address of the compute entity. An update of the mapping in the entry of the ARP table 118 remaps a second MAC address to the first IP address, the second MAC address being different from the first MAC address. Responsive to the detecting this update, the control plane 112 updates the given entry of the MAC address table 116 to replace the first MAC address with the second MAC address. In an example, an update of an ARP table entry may occur if a virtual compute entity, such as a VM or container, is replaced with a replacement virtual compute entity, which can result in an assignment of a new MAC address to the replacement virtual compute entity.

The control plane 112 further monitors (at 216) for changes in correlations between IP addresses and roles in entries of the role mapping data structure 132. A change may occur, for example, if an administrator assigns a new role to an existing aggregation of IP addresses, or alternatively, assigns an existing role to a new aggregation of IP addresses. In response to detecting a change in a correlation between an IP address and a role, the role setting engine 122 of the control plane 112 can update (at 218) respective entries of the ARP table 118 and the MAC address table 116.

The following provides specific examples regarding assignment of roles to aggregations of IP addresses and entries of the ARP table 118 and the MAC address table 116. Table 1 lists various roles assigned to respective aggregations of IP addresses. The examples provided include IPv4 addresses. Similar examples can also be provided for IPv6 addresses.

TABLE 1

| | Aggregation of | |
|---|---|---|
| Entry Number | IP Addresses | Role |
| 1 | 0.0.0.0/0 | Guest |
| 2 | 192.168.0.0/16 | Intern |
| 3 | 192.168.1.0/24 | Employee |
| 4 | 192.168.2.0/24 | Contingent |
| 5 | 192.168.3.0/24 | IT |
| 6 | 172.168.0.0/16 | Security |
| 7 | 192.168.1.10/32 | Finance |

In Table 1, the Entry Number column identifies an entry that correlates an aggregation of IP addresses to a respective role. For example, Entry Number 3 correlates the aggregation of IP addresses 192.168.1.0/24 to the Employee role. The entries of Table 1 may be present in the role mapping data structure 132 of FIG. 1, for example. If the role mapping data structure 132 is a role trie, then the entries of Table 1 may be represented by leaf nodes of the role trie.

Table 2 below shows matching (longest prefix matching) of host IP addresses to entries of Table 1. A host IP address is the IP address of a compute entity.

TABLE 2

| | Matched Entry | |
|---|---|---|
| Host IP address | Number | Assigned Role |
| 192.168.1.10 | 7 | Finance |
| 192.168.1.11 | 3 | Employee |
| 192.168.2.10 | 4 | Contingent |
| 192.168.3.10 | 5 | IT |
| 192.168.4.10 | 2 | Intern |
| 172.168.1.10 | 6 | Security |
| 172.169.1.10 | 1 | Guest |

In Table 2, the host IP address 192,168.1.10 has a longest prefix match to entry 7 of Table 1, where entry 7 contains the following aggregation of IP addresses: 192.168.1.10/32, which specifies that the entire length (32 bits as specified by the IP mask of 32) of the IP address is correlated to the Finance role.

In Table 2, the host IP address 192.168.1.11 has a longest prefix match to entry 3 of Table 1, where entry 3 contains the following aggregation of IP addresses: 192.168.1.0/24. This aggregation of IP addresses, 192.168.1.0/24, has an IP mask of 24, which indicates that the routing prefix includes the first 24 bits of the IP address, i.e., 192.168.1. The routing prefix, 192.168.1, defines the aggregation of IP addresses.

Table 3 below lists various layer 3 interfaces configured at a network switch, where a respective VLAN identified by a VLAN identifier is configured on a respective layer 3 interface. Table 3 includes 5 VLAN identifiers representing 5 respective VLANs configured on respective layer 3 interfaces of the network switch.

TABLE 3

| Layer 3 | | |
|---|---|---|
| Interface | IP Address | IP Mask |
| VLAN100 | 192.168.1.1 | 255.255.255.0 |
| VLAN200 | 192.168.2.1 | 255.255.255.0 |
| VLAN300 | 192.168.3.1 | 255.255.255.0 |
| VLAN400 | 192.168.4.1 | 255.255.255.0 |
| VLAN500 | 172.168.1.1 | 255.0.0.0 |

The entries of Table 3 correlate layer 3 interfaces (VLANs) to corresponding IP addresses. The IP Mask column specifies the routing prefix of each IP address that is to be matched to a host IP address.

For the configuration represented by Table 3, Table 4 below depicts entries of an example ARP table. The Role column represents a Role field specifying a role of a compute entity.

TABLE 4

| | Layer 3 | | |
|---|---|---|---|
| Host IP address | Interface | MAC Address | Role |
| 192.168.1.10 | VLAN100 | 4a:00:00:00:00:01 | Finance |
| 192.168.1.11 | VLAN100 | 4a:00:00:00:00:02 | Employee |
| 192.168.2.10 | VLAN200 | 4a:00:00:00:00:03 | Contingent |
| 192.168.3.10 | VLAN300 | 4a:00:00:00:00:04 | IT |
| 192.168.4.10 | VLAN400 | 4a:00:00:00:00:05 | Intern |
| 172.169.1.10 | VLAN500 | 4a:00:00:00:00:06 | Guest |
| 172.168.1.10 | VLAN500 | 4a:00:00:00:00:07 | Security |

The example ARP table correlates host IP addresses to layer 3 interfaces, MAC addresses, and roles. The role of each entry of the example ARP table is programmed by the role setting engine 122 of FIG. 1.

Table 5 below depicts entries of an example MAC address table. The Role column represents a Role field specifying a role of a compute entity.

TABLE 5

| VLAN | MAC | Physical Interface | Role |
|---|---|---|---|
| VLAN100 | 4a:00:00:00:00:01 | “1/1/1” | Finance |
| VLAN100 | 4a:00:00:00:00:02 | “1/1/2” | Employee |
| VLAN200 | 4a:00:00:00:00:03 | “1/1/3” | Contingent |
| VLAN300 | 4a:00:00:00:00:04 | “1/1/4” | IT |
| VLAN400 | 4a:00:00:00:00:05 | “1/1/5” | Intern |
| VLAN500 | 4a:00:00:00:00:06 | “1/1/6” | Guest |
| VLAN500 | 4a:00:00:00:00:07 | “1/1/7” | Security |

The Physical Interface column of the example MAC address table refers to a physical interface of a network switch. Each entry of the example MAC address table correlates a VLAN, a MAC address, a physical interface, and a role. The role of each entry of the example MAC address table is programmed by the role setting engine 122 of FIG. 1.

Given the example ARP table of Table 4 and the example MAC address table of Table 5, the following describes how these tables are used. A first example involves forwarding a packet of switched traffic (transmitted from a source device to a destination device that are part of the same VLAN). In this first example, in response to receiving the packet containing a destination MAC address of the destination device, the network switch performs a lookup of the MAC address table. A second example involves forwarding a packet of routed traffic (transmitted from a source device to a destination device that below to different VLANs). In the second example, in response to receiving a packet containing source and destination IP addresses, the network switch performs a lookup of the ARP table to retrieve the destination MAC address of the destination device.

Table 6 below shows examples of different types of traffic flows, including access-to-access traffic flows and network-to-access traffic flows. The Source IP column includes source IP addresses, the Destination IP column includes destination IP addresses, the Type of Lookup column indicates whether a lookup of the MAC address table or a lookup of the ARP table is performed, and the Traffic Flow Type column identifies the type of traffic flow.

TABLE 6

| Source IP | Destination IP | Type of Lookup | Traffic Flow Type |
|---|---|---|---|
| 192.168.1.11 | 192.168.1.10 | MAC | Access-to-access |
| 192.168.1.12 | 192.168.1.10 | MAC | Network-to-access |
| 192.168.3.10 | 192.168.1.10 | ARP | Access-to-access |
| 192.168.3.11 | 192.168.1.10 | ARP | Network-to-access |

Each entry of Table 6 depicts a packet being sent to the same destination IP address, 192.168.1.10. The first two entries of Table 6 show examples involving a packet being sent from a source device to a destination device that are part of the same VLAN, which results in a MAC address table lookup. The last two entries of Table 6 show examples involving a packet being sent from a source device to a destination device that are part of the different VLANs, which results in an ARP table lookup.

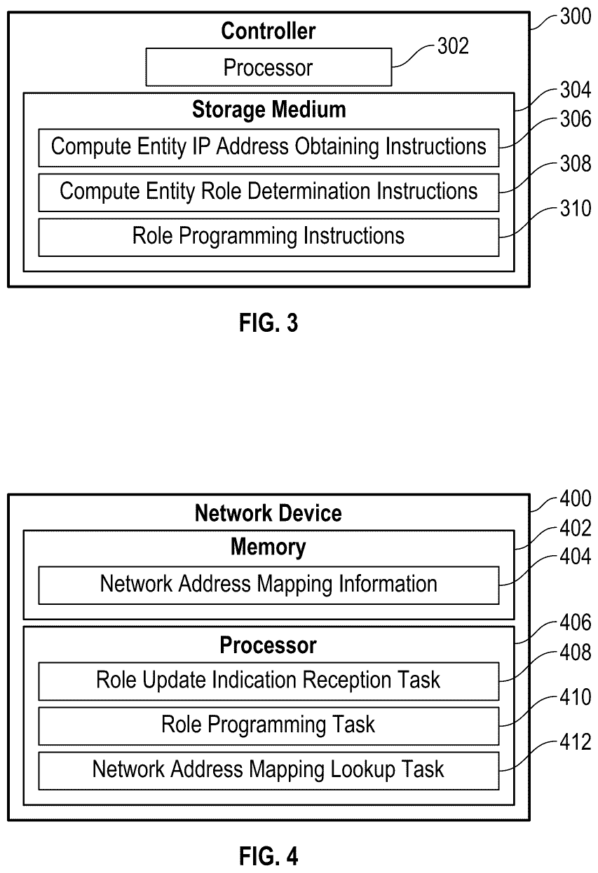

FIG. 3 is a block diagram of a controller 300. In some examples, the controller 300 is part of the control plane 112 in the network switch 102A of FIG. 1. In other examples, the controller 300 is separate from a network switch, and can be used to perform control functionalities with respect to one or more network switches. The controller 300 includes a hardware processor 302 (or multiple hardware processors). The controller 300 further includes a non-transitory machine-readable or computer-readable storage medium 304 storing machine-readable instructions executable on the hardware processor 302 to perform various tasks. Machine-readable instructions executable on a hardware processor can refer to the instructions executable on a single hardware processor or the instructions executable on multiple hardware processors.

The machine-readable instructions include compute entity IP address obtaining instructions 306 to obtain an IP address of a compute entity that is to communicate over a network. The compute entity can be a virtual compute entity or a physical compute entity.

The machine-readable instructions include compute entity role determination instructions 308 to determine a role for the compute entity by accessing, using the obtained IP address, a role mapping data structure that maps roles to IP addresses. In some examples, the role mapping data structure includes a tree structure having nodes each including a mapping of an IP address (or multiple IP addresses) to a role. For example, the tree structure can be a role trie, such as a Patricia trie. In other examples, the role mapping data structure can be in a different form.

The machine-readable instructions include role programming instructions 310 to add the determined role to network address mapping information in the network. The network address mapping information includes entries having respective network addresses correlated to roles of compute entities. The determined role added to the network address mapping information is for use by a network device of the network in applying policy enforcement for traffic through the network device.

In some examples, an entry of the role mapping data structure maps an aggregation of IP addresses to a role. Mapping an aggregation of IP addresses to a role can refer to either mapping a single aggregation of IP addresses to a role, or mapping multiple aggregations of IP addresses to a role.

In some examples, the accessing of the role mapping data structure using the obtained IP address comprises performing a longest prefix match of the obtained IP address with the IP addresses in the role mapping data structure.

In some examples, the longest prefix match returns an entry of the role mapping data structure containing the role correlated with an aggregation of IP addresses matched to the obtained IP address.

In some examples, the machine-readable instructions obtain the IP address of the compute entity by performing a lookup of an ARP table using a Media Access Control (MAC) address of the compute entity, the lookup of the ARP table using the MAC address of the compute entity returning the IP address of the compute entity.

In some examples, the network address mapping information includes a MAC address table, and the determined role is added to an entry of the MAC address table that contains a first MAC address of the compute entity and a role field set to the determined role. An entry of the ARP table includes a mapping between the first MAC address of the compute entity and a first IP address of the compute entity. The machine-readable instructions detect an update of the mapping in the entry of the ARP table that remaps a second MAC address to the first IP address, the second MAC address being different from the first MAC address. Responsive to the detecting of the update, the machine-readable instructions update the entry of the MAC address table to replace the first MAC address with the second MAC address.

In some examples, the controller is part of a control plane of a network environment, and the network device to apply the policy enforcement is part of a data plane of the network environment.

In some examples, the machine-readable instructions detect an update of an entry of the role mapping data structure. Based on the update of the entry of the role mapping data structure, the machine-readable instructions update a role in an entry of the network address mapping information.

FIG. 4 is a block diagram of a network device 400 of a network environment. An example of the network device 400 is the network switch 102A or 102B of FIG. 1. The network device 400 can include other types of network devices in other examples.

The network device 400 includes a memory 402 to store network address mapping information 404 including entries having respective network addresses correlated to respective roles of compute entities. The network device 400 further includes a hardware processor 406 (or multiple hardware processors) to perform various tasks.

The tasks of the hardware processor 406 include a role update indication reception task 408 to receive an update indication from a controller in a control plane of the network environment. The update indication to set a role of a compute entity.

The tasks of the hardware processor 406 include a role programming task 410 to, responsive to the update indication, add role information to a role field of an entry of the network address mapping information 404. The role information specifies the role of the compute entity identified by a network address in the entry.

The tasks of the hardware processor 406 include a network address mapping lookup task 412 to, as part of forwarding a packet sent from or to the compute entity, perform a lookup of the network address mapping information to determine the role of the compute entity.

In some examples, the network device 400 the processor applies policy enforcement using a policy corresponding to the role.

In some examples, the hardware processor 406 adds an indicator of the role to a header of the packet, and sends the packet with the indicator to another network device.

In some examples, the hardware processor 406 encapsulates the packet in a virtual tunnel header, where the indicator is part of the virtual tunnel header. The virtual tunnel header may be a VXLAN header, for example. The sending of the packet with the indicator includes sending the encapsulated packet.

In some examples, the network address mapping information 404 includes a MAC address table and an ARP table. For switched traffic between the compute entity and another compute entity both belonging to one VLAN, the hardware processor 406 accesses the MAC address table to determine the role of the compute entity. For routed traffic between the compute entity and another compute entity belonging to different VLANs, the hardware processor 406 accesses the ARP table to determine the role of the compute entity.

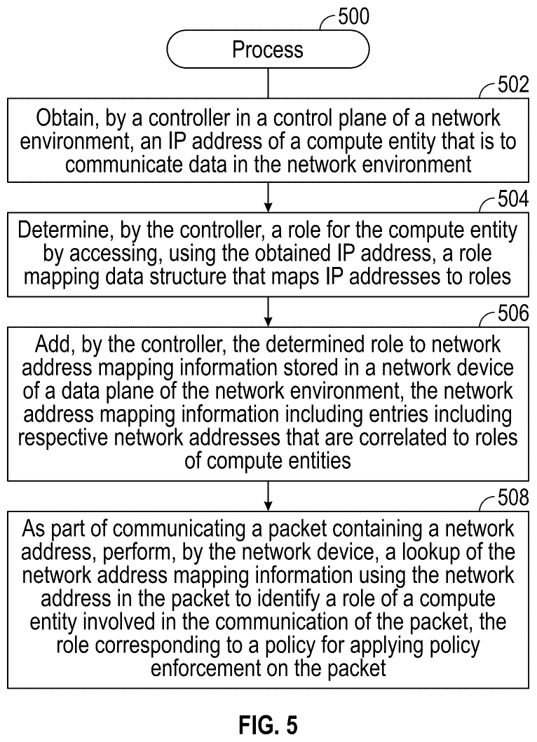

FIG. 5 is a flow diagram of a process 500 according to some examples. The process 500 includes obtaining (at 502), by a controller in a control plane of a network environment, an IP address of a compute entity that is to communicate data in the network environment.

The process 500 includes determining (at 504), by the controller, a role for the compute entity by accessing, using the obtained IP address, a role mapping data structure that maps IP addresses to roles. The role mapping data structure may be a role trie or another type of data structure.

The process 500 includes adding (at 506), by the controller, the determined role to network address mapping information stored in a network device of a data plane of the network environment. The network address mapping information includes entries including respective network addresses that are correlated to roles of compute entities.

As part of communicating a packet containing a network address, the process 500 includes performing (at 508), by the network device, a lookup of the network address mapping information using the network address in the packet to identify a role of a compute entity involved in the communication of the packet, the role corresponding to a policy for applying policy enforcement on the packet.

A hardware processor can include a microprocessor, a core of a multi-core microprocessor, a microcontroller, a programmable integrated circuit, a programmable gate array, or another hardware processing circuit.

A memory can be implemented using one or more memory devices, such as any or some combination of dynamic random access memory (DRAM) devices, static random access memory (SRAM) devices, flash memory devices, or other types of memory devices.

Examples of electronic devices include any or some combination of the following: a desktop computer, a notebook computer, a tablet computer, a smartphone, a server computer, an Internet of Things (IoT) device, a game appliance, a household appliance, a vehicle, a storage system, a communication node, or any other type of electronic device.

As used here, an “engine” or a “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” or a “controller” can refer to a combination of one or more hardware processing circuits and machine-readable instructions (software and/or firmware) executable on the one or more hardware processing circuits.

A “table” can refer to any data structure for storing information.

A storage medium (e.g., 304 in FIG. 3) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A controller comprising:
a processor; and
a non-transitory storage medium comprising instructions executable on the processor to:
obtain an Internet Protocol (IP) address of a compute entity that is to communicate over a network;
determine a role for the compute entity by accessing, using the obtained IP address, a role mapping data structure that maps IP addresses to roles; and
add the determined role to network address mapping information of the network, the network address mapping information comprising entries including respective network addresses, the determined role in the network address mapping information for use by a network device of the network in applying policy enforcement for traffic through the network device.

2. The controller of claim 1, wherein the role mapping data structure comprises a tree structure comprising nodes each including a mapping of an IP address to a role.

3. The controller of claim 1, wherein an entry of the role mapping data structure maps an aggregation of IP addresses to a role.

4. The controller of claim 3, wherein the accessing of the role mapping data structure using the obtained IP address comprises performing a longest prefix match of the obtained IP address with the IP addresses in the role mapping data structure.

5. The controller of claim 4, wherein the longest prefix match returns an entry of the role mapping data structure containing the role correlated with an aggregation of IP addresses matched to the obtained IP address.

6. The controller of claim 1, wherein the network address mapping information comprises a Media Access Control (MAC) address table, and the determined role is added to an entry of the MAC address table that contains a MAC address of the compute entity and a role field set to the determined role.

7. The controller of claim 1, wherein the network address mapping information comprises an Address Resolution Protocol (ARP) table, and the determined role is added to an entry of the ARP table that contains the IP address of the compute entity, a Media Access Control (MAC) address of the compute entity, and a role field set to the determined role.

8. The controller of claim 1, wherein the instructions are executable on the processor to:
obtain the IP address of the compute entity by performing a lookup of an Address Resolution Protocol (ARP) table using a Media Access Control (MAC) address of the compute entity, the lookup of the ARP table using the MAC address of the compute entity returning the IP address of the compute entity.

9. The controller of claim 8, wherein the network address mapping information comprises a MAC address table, and the determined role is added to an entry of the MAC address table that contains a first MAC address of the compute entity and a role field set to the determined role, wherein an entry of the ARP table comprises a mapping between the first MAC address of the compute entity and a first IP address of the compute entity.

10. The controller of claim 9, wherein the instructions are executable on the processor to:
detect an update of the mapping in the entry of the ARP table that remaps a second MAC address to the first IP address, the second MAC address being different from the first MAC address; and
responsive to the detecting of the update, update the entry of the MAC address table to replace the first MAC address with the second MAC address.

11. The controller of claim 1, wherein the controller is part of a control plane of a network environment, and the network device to apply the policy enforcement is part of a data plane of the network environment, and wherein the accessing of the role mapping data structure using the obtained IP address comprises performing a longest prefix match of the obtained IP address with the IP addresses in the role mapping data structure to determine the role of the compute entity.

12. The controller of claim 1, wherein the instructions are executable on the processor to:
detect an update of an entry of the role mapping data structure; and
based on the update of the entry of the role mapping data structure, update a role in an entry of the network address mapping information.

13. A network device for a data plane of a network environment, the network device comprising:
a memory to store network address mapping information comprising entries including respective network addresses correlated to respective roles of compute entities; and
a processor to:
receive an update indication from a controller in a control plane of the network environment, the update indication to set a role of a compute entity,
responsive to the update indication, add role information to a role field of an entry of the network address mapping information, the role information specifying the role of the compute entity identified by a network address in the entry, and
to forward a packet sent from or to the compute entity, perform a lookup of the network address mapping information to determine the role of the compute entity.

14. The network device of claim 13, wherein the processor is to apply policy enforcement using a policy corresponding to the role.

15. The network device of claim 13, wherein the processor is to:
add an indicator of the role to a header of the packet, and
send the packet with the indicator to another network device.

16. The network device of claim 15, wherein the processor is to:
encapsulate the packet in a virtual tunnel header, wherein the indicator is part of the virtual tunnel header, and
wherein the sending of the packet with the indicator comprises sending the encapsulated packet.

17. The network device of claim 13, wherein the network address mapping information comprises a Media Access Control (MAC) address table and an Address Resolution Protocol (ARP) table, and the processor is to:
for switched traffic between the compute entity and another compute entity both belonging to one virtual local area network (VLAN), access the MAC address table to determine the role of the compute entity, and
for routed traffic between the compute entity and another compute entity belonging to different VLANs, access the ARP table to determine the role of the compute entity.

18. The network device of claim 13, wherein the update indication is from the controller that determined the role of the compute entity using a role mapping data structure that correlates aggregations of Internet Protocol (IP) addresses.

19. A method comprising:
obtaining, by a controller in a control plane of a network environment, an Internet Protocol (IP) address of a compute entity that is to communicate data in the network environment;
determining, by the controller, a role for the compute entity by accessing, using the obtained IP address, a role mapping data structure that maps IP addresses to roles;
adding, by the controller, the determined role to network address mapping information stored in a network device of a data plane of the network environment, the network address mapping information comprising entries including respective network addresses that are correlated to roles of compute entities; and
as part of communicating a packet containing a network address, performing, by the network device, a lookup of the network address mapping information using the network address in the packet to identify a role of a compute entity involved in the communication of the packet, the role corresponding to a policy for applying policy enforcement on the packet.

20. The method of claim 19, wherein the network address mapping information comprises:
a Media Access Control (MAC) address table that correlates MAC addresses to the roles of the compute entities, or
an Address Resolution Protocol (ARP) table that correlates Internet Protocol (IP) addresses to the roles of the compute entities.
